(19) United States
(12) Patent Application Publication
(10) Pub. No.: US 2025/0254588 A1
(43) Pub. Date: Aug. 7, 2025

(54) Wireless Communication Protection Method and System Capable of Reducing Coexistence Interference for Coexistence Networks

(71) Applicant: MEDIATEK INC., Hsinchu City (TW)

(72) Inventors: Ching-Heng Su, Hsinchu City (TW); Yi-Chiao Lin, Hsinchu City (TW); Wei-Hao Chung, Hsinchu City (TW); Yirui Yan, Chengdu (CN); Chien-I Lu, Hsinchu City (TW)

(73) Assignee: MEDIATEK INC., Hsinchu City (TW)

(21) Appl. No.: 19/021,120

(22) Filed: Jan. 14, 2025

(30) Foreign Application Priority Data
Feb. 6, 2024 (CN) 202410171599.9
Jan. 7, 2025 (CN) 202510022920.1

(51) Int. Cl. H04W 36/20; H04W 4/80; H04W 84/14

(52) U.S. Cl. CPC H04W 36/20; H04W 4/80; H04W 84/14

(57) ABSTRACT

A wireless communication protection method includes receiving a transmission request by a first device from a third device; arbitrating coexistence from at least the first network and the third network by the first device according to at least access priorities of the first network and the third network, upon identifying that the transmission request indicates a sending request; transmitting a protection signal by the first device for disabling communications from the second device to the first device when the third device is granted access to communicate with the fourth device through the third network; and transmitting a grant signal indicating a grant state from the first device to the third device for enabling the third device to communicate with the fourth device through the third network after the communications from the second device to the first device are disabled.

### BACKGROUND

The rapid growth of wireless communication technology has led to a proliferation of standard protocols, such as Wi-Fi, Bluetooth, ZigBee, and Thread. However, many of these technologies operate within the same 2.4 GHz frequency band, creating the potential for interference and performance degradation.

Conventional systems often lack robust mechanisms to protect against such interference. Therefore, developing a wireless communication protection method to mitigate interference is crucial.

### SUMMARY

In an embodiment of the present invention, a wireless communication protection method is disclosed. The wireless communication protection method comprises receiving a transmission request by a first device from a third device, wherein the first device and the third device are linked via a wired interface, the first device is configured to communicate with a second device through a first network, and the third device is configured to communicate with a fourth device through a third network, arbitrating coexistence from at least the first network and the third network by the first device according to at least access priorities of the first network and the third network, upon identifying that the transmission request indicates a sending request, transmitting a protection signal by the first device for disabling communications from the second device to the first device when the third device is granted access to communicate with the fourth device through the third network, and transmitting a grant signal indicating a grant state from the first device to the third device for enabling the third device to communicate with the fourth device through the third network after the communications from the second device to the first device are disabled.

In another embodiment of the present invention, a wireless communication protection system is disclosed. The wireless communication protection system comprises a first device and a third device, and optionally, a second device and a fourth device. The first device is configured to communicate with the second device through a first network. The third device is linked to the first device via a wired interface. The third device is configured to communicate with the fourth device through a third network. The first device is further configured to receive a transmission request from the third device, to arbitrate coexistence from at least the first network and the third network according to at least access priorities of the first network and the third network, upon identifying that the transmission request indicates a sending request, to transmit a protection signal for disabling communications from the second device to the first device when the third device is granted access to communicate with the fourth device through the third network, and to transmit a grant signal indicating a grant state to the third device for enabling the third device to communicate with the fourth device through the third network after the communications from the second device to the first device are disabled.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a wireless communication protection system according to an embodiment of the present invention.

FIG. 2 illustrates a Wi-Fi protection mechanism under a first mode of the wireless communication protection system.

FIG. 3 illustrates the Wi-Fi protection mechanism under a second mode of the wireless communication protection system.

FIG. 4 illustrates the Wi-Fi protection mechanism under a third mode of the wireless communication protection system.

FIG. 5 illustrates the Wi-Fi protection mechanism under a fourth mode of the wireless communication protection system.

FIG. 6 illustrates the Wi-Fi protection mechanism under a fifth mode of the wireless communication protection system.

FIG. 7 illustrates a flow chart of performing a wireless communication protection method by the wireless communication protection system in FIG. 1.

### DETAILED DESCRIPTION

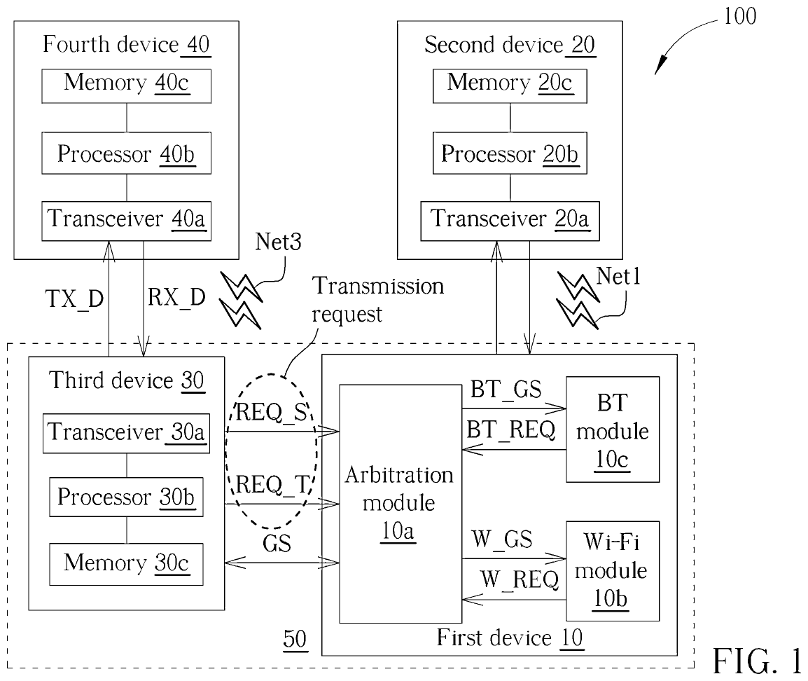

FIG. 1 is a block diagram of a wireless communication protection system 100 according to an embodiment of the present invention. The wireless communication protection system 100 aims to mitigate interference and ensure efficient communication among different wireless technologies coexisting in the same device, such as Wi-Fi, Bluetooth, and Thread. The motivation behind the wireless communication protection system 100 is to create a robust mechanism that protects against interference, especially for technologies like Thread, which are vulnerable to disruption from Wi-Fi communication. The wireless communication protection system 100 incorporates a coexistence arbitration process that prioritizes different wireless technologies based on their access priorities, ensuring efficient allocation of airtime. This arbitration process helps to resolve conflicts and improve overall system performance by effectively managing interference and prioritizing communication needs.

In FIG. 1, the wireless communication protection system 100 includes a first device 10 and a third device 30, and optionally, a second device 20 and a fourth device 40. The first device 10 can be a combination chip or device that supports Wi-Fi and Bluetooth (BT) functionality and is capable of communicating with the second device 20 through the Wi-Fi network (as an example of a first network). The first device 10 includes an arbitration module 10a, a Wi-Fi module 10b, and a BT module 10c. The arbitration module 10a, also referred to as the Packet Traffic Arbitration (PTA) module, is configured to perform coexistence arbitration. Specifically, the arbitration module 10a is configured to check a transmission request and priority of each related network and determine which network (i.e., Wi-Fi, BT, or Thread network, etc., for example, the BT network can be taken as an example of a second network) can perform data transmission and reception. In this embodiment, the third device 30 uses the Thread network protocol and is configured to communicate with the fourth device 40 based on the Thread network (as an example of a third network). When the third device 30 needs to perform data transmission or reception through the Thread network, it sends a transmission request (the transmission request can be used to indicating a sending request or a receiving request or an idle state, in the embodiment, the transmission request is implemented through a request state signal REQ_S and a request type signal REQ_T, however, the present disclosure is not limited thereto. For example, similar functions can be realized through at least two bits of a specific signal) to the first device 10. The request state signal REQ_S is used to indicate whether a transmission request is in an activation state, while the request type signal REQ_T is used to indicate a type of the transmission request, for example, indicating a sending/transmitting (TX) type for a request to send/transmit data or a receiving (RX) type for a request to receive data. In one example, the request state signal REQ_S indicating the activation state and the request type signal REQ_T indicating the transmitting (TX) type can jointly indicate a sending request, which means that the third device desires to perform a transmitting operation via the third network. In another example, the request state signal REQ_S indicating the activation state and the request type signal REQ_T indicating the receiving (RX) type can jointly indicate a receiving request, which means that the third device desires to perform a receiving operation via the third network. In addition, the request state signal REQ_S indicating the idle state is used to indicate that the transmission request is not enabled regardless of the request type signal REQ_T. The first device 10 then sends a grant signal GS to the third device 30. The grant signal GS indicates whether the third device's request is granted. Here, the grant signal GS carries a message of a grant state of the third device 30 permitted by the first device 10, hereafter called as, the grant signal GS indicating the grant state or a non-grant state. The Wi-Fi module 10b is linked to the arbitration module 10a for performing Wi-Fi communications according to a Wi-Fi request signal W_REQ and a Wi-Fi grant signal W_GS. The BT module 10c is linked to the arbitration module 10a for performing BT communications according to a BT request signal BT_REQ and a BT grant signal BT_GS.

The second device 20 is used to communicate with the first device 10 through a first network, Net1 (hereinafter referred to as Wi-Fi network Net1). The second device 20 includes a transceiver 20a, a processor 20b coupled to the transceiver 20a, and a memory 20c coupled to the processor 20b. The transceiver 20a enables wireless communication by sending and receiving radio frequency signals through the Wi-Fi network Net1. The processor 20b is configured to execute instructions and controlling the overall operation of the second device 20. The memory 20c stores both data and instructions required for operations of the second device 20, such as data of the operating system, networking protocols, and any application-specific software. The second device 20 can be an access point (AP) in Wi-Fi network Net1.

The third device 30 is connected to the first device 10 through a predefined wired interface (such as 3-wire interface in present embodiment, but it not limited to thereto). The third device 30 includes a transceiver 30a, a processor 30b coupled to the transceiver 30a, and a memory 30c coupled to the processor 30b. The transceiver 30a enables wireless communication by sending and receiving radio frequency signals (such as a transmitting signal TX_D and a receiving signal RX_D) through the third network, Net3 (hereinafter referred to as the Thread network Net3). The processor 30b is configured to execute instructions and control the overall operation of the third device 30. The memory 30c stores both data and instructions required for operations of the third device 30. In the embodiment, the third device 30 can be a radio chip that operates based on the Thread network protocol, which is different from Bluetooth and Wi-Fi protocols. It is used to communicate with the fourth device 40 through the Thread network Net3. When the third device 30 needs to send data or receive data through the Thread network Net3, it sends the request state signal REQ_S and the request type signal REQ_T to the first device 10. Further, the third device 30 and the first device 10 can be integrated into a communication device 50, allowing the communication device 50 to support both Wi-Fi/BT and Thread functionalities. In the embodiment, the wireless communication protection system 100 at least includes the communication device 50.

The fourth device 40 is used to communicate with the third device 30 through the Thread network Net3. The fourth device 40 includes a transceiver 40a, a processor 40b coupled to the transceiver 40a, and a memory 40c coupled to the processor 40b. Similarly, the transceiver 40a enables wireless communication by sending and receiving radio frequency signals through the Thread network Net3. The processor 40b is configured to execute instructions and control the overall operation of the fourth device 40. The memory 40c stores both data and instructions required for operations of the fourth device 40.

In the wireless communication protection system 100, the first device 10 receives the request state signal REQ_S and the request type signal REQ_T from the third device 30 when the third device 30 desires to communicate with the fourth device 40 through the Thread network Net3. The first device 10 arbitrates coexistence from at least the Wi-Fi network Net1 and the Thread network Net3 according to at least access priorities of the Wi-Fi network Net1 and the Thread network Net3 after the first request state signal REQ_S and the first request type signal REQ_T are identified as the sending request by the first device 10. The first device 10 transmits a protection signal through the first network Net1 (which is a network through which the first device 10 and the second device 20 communicate) for disabling communications from the second device 20 to the first device 10 when the third device 30 is granted access to communicate with the fourth device 40 through the Thread network Net3. The first device 10 transmits a grant signal indicating a grant state to the third device 30 for enabling the third device 30 to communicate with the fourth device 40 through the Thread network Net3 after the communications from the second device 20 to the first device 10 are disabled.

In other words, the wireless communication protection system 100 is designed to facilitate communication between devices using different wireless technologies, for example, Wi-Fi and Thread. The wireless communication protection system 100 includes two pairs of devices: the first device 10 and the second device 20, which communicate over the Wi-Fi network Net1; and the third device 30 and the fourth device 40, which communicate over the Thread network Net3. For example, the wireless communication protection system 100 prioritizes communication between the third device 30 and the fourth device 40 by temporarily pausing Wi-Fi communication between the first device 10 and the second device 20. This is achieved by sending a specific signal (i.e., the protection signal mentioned above) by the first device 10 through the first network Net1, prompting the second device 20 to temporarily pause or disable Wi-Fi communication from the second device 20 to the first device 10. After the Thread communication is complete, the first device will inform the second device 20, allowing it to resume Wi-Fi communication. Details of the Wi-Fi protection mechanism are illustrated below.

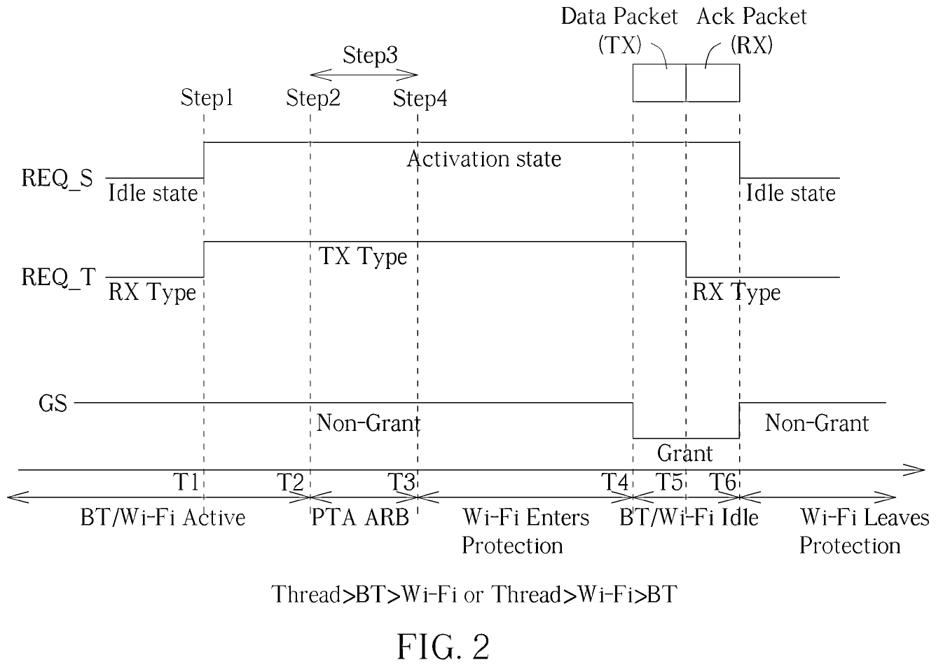

FIG. 2 illustrates a Wi-Fi protection mechanism under a first mode of the wireless communication protection system. In general, the first device 10 can also support a second network, but it is not limited to thereto. The second network is different from the first network and the third network. In the embodiment, the second network is a BT network. In the first mode, access priorities of the Wi-Fi network, the BT network, and the Thread network are acquired by the first device 10. In FIG. 2, the Thread network has the highest priority (say, Thread network>BT network>Wi-Fi network, or Thread network>Wi-Fi network>BT network). The access priorities are predetermined or obtained through a combination of factors, including the type of wireless technology, the specific use case, and the desired performance characteristics. These access priorities are typically determined during the design and configuration phase of the system. They are programmed into the device's firmware or software and can be adjusted by the user. In FIG. 2, X-axis is a timeline. The request state signal REQ_S indicates whether the third device 30 (e.g., Thread device) is requesting access to wireless communication through the Thread network. For example, the request state signal REQ_S=1 indicates that the third device 30 is requesting access (Activation State). The request state signal REQ_S=0 indicates that the third device 30 is not requesting access (Idle State). The request type signal REQ_T specifies the type of communication to be performed. For example, the request type signal REQ_T=1 indicates that the request is for data transmission (TX Type). The request type signal REQ_T=0 indicates that the request is for data reception (RX Type). The grant signal GS is sent from the first device 10 (e.g., Wi-Fi/Bluetooth combo chip) to the third device 30, indicating whether the transmission request is granted. For example, the grant signal GS=0 indicates that the request is granted, referred as the grant signal GS indicating the grant state. The third device 30 is allowed to access the Thread network. The grant signal GS=1 indicates that the request is not granted, referred as the grant signal GS indicating the non-grant state. Hence, the third device 30 must wait to access the Thread network.

In FIG. 2, at time point T1, the third device 30 sends the request state signal REQ_S=1 (i.e., in the activation state) to the first device 10, indicating that the request is activated to request transmit/receive data through the Thread network. The request type signal REQ_T=1 is transmitted from the third device 30 to the first device 10, indicating TX Type. The grant signal GS is configured as “1” to indicate the non-grant state because the coexistence arbitration is not yet complete. At time point T2, the request state signal REQ_S remains at “1”. The request type signal REQ_T remains at “1”. The grant signal GS remains at “1”. The first device 10 enters the PTA process to perform the coexistence arbitration. The first device 10 checks the request type and priority of the Thread network. Because the Thread network has the highest priority, the first device 10 determines to grant access to the third device 30. At time point T3, the request state signal REQ_S remains at “1”. The request type signal REQ_T remains at “1”. The grant signal GS remains at “1”. The first device 10 transmits a protection signal through the first network to disable communications from the second device 20 to the first device 10 (e.g., Wi-Fi enters protection). As a result, because the second device 20 can temporarily pause or disable Wi-Fi communication from the second device 20 to the first device 10 according to the protection signal, no air-interference is generated by the second device 20. It can be understood that two types of protection signals can be used. One protection signal type is a null packet carrying a power management (PM) field. Another protection signal type is clear-to-send (CTS)-to-self packets. Details are illustrated later. At time point T4, the request state signal REQ_S remains at “1”. The request type signal REQ_T remains at “1”. The grant signal GS is changed from “1” to “0”, indicating that the non-grant state is changed to the grant state. Therefore, the third device 30 is now granted access to communicate with the fourth device 40 through the Thread network. The Bluetooth and Wi-Fi functions of the first device 10 are in an idle state. The third device 30 transmits a data packet to the fourth device 40 through the Thread network after the third device 30 receives the grant signal GS=0 indicating the grant state. After the data packet is completely transmitted, at time point T5, the request state signal REQ_S remains at “1”. The request type signal REQ_T is changed from “1” to “0”, indicating that the third device 30 is switched to a data receiving (RX Type) mode. The grant signal GS remains at “0”. The third device 30 can receive an acknowledgment (ACK) signal (packet) from the fourth device 40. After the acknowledgment signal is received by the third device 30, at time point T6, the request state signal REQ_S is changed from “1” to “0”, indicating that the request is no longer active. The request type signal REQ_T remains at “0”. The grant signal GS is changed from “0” to “1”, indicating that the grant state is changed to the non-grant state. The first device 10 notifies the third device 30 that it is no longer granting it access to the Thread network. After time point T6, the first device 10 can send another null packet with PM=0 to the second device and the second device leaves Wi-Fi protection. Therefore, the communications between the first device 10 and the second device 20 can be resumed. In other words, at time point T6, because the TX/RX period of the third device 30 is completely performed, the first device 10 can transmit the grant signal GS=1 indicating the non-grant state to the third device 30 to prevent the third device 30 from communicating with the fourth device 40 through the Thread network.

In brief, a four-step process is introduced to mitigate interference between coexisting networks. In Step 1, the first device 10 receives a transmission request from the third device 30. This transmission request comprises two key pieces of information: the request state signal REQ_S and the request type signal REQ_T. In Step 2, the first device 10 identifies/samples the request state signal REQ_S and the request type signal REQ_T to ascertain whether the third device 30 is requesting to transmit (TX Type) or receive (RX Type) data. In Step 3, upon identifying the request state signal REQ_S and the request type signal REQ_T indicating the sending request, the first device 10 initiates the coexistence arbitration process. This process entails determining which network (e.g., Wi-Fi, Bluetooth, or Thread) is granted access for data communications. The coexistence arbitration process considers the access priority levels of the involved networks. These access priority levels are typically pre-programmed into the device's firmware or software, though they can be adjusted by the user. In Step 4, the first device 10 transmits the grant signal GS to the third device 30, indicating the result of the arbitration process (grant or non-grant). This grant signal GS informs the third device 30 whether it has been granted access to the Thread network for data communications. Notably, the grant signal GS is set to “grant (such as GS=0, indicating the grant state)” only after the arbitration process concludes and the Wi-Fi protection mechanism is successfully initiated. This ensures that the third device 30 can transmit data without interference from Wi-Fi traffic.

As previously mentioned, the protection signal type can be CTS-to-self packets or the null packet carrying the PM field. In a scenario where the first device 10 supports Wi-Fi Neighborhood Aware Networking (NAN) function, the first device 10 can initiate Wi-Fi protection by sending CTS-to-self packets periodically. This involves periodically transmitting these packets at predetermined intervals, effectively prompting the second device 20 to temporarily halt its transmission to the first device 10. This mechanism ensures that the second device 20 remains silent to the first device 10 during the Wi-Fi protection period. To deactivate or leave Wi-Fi protection, the first device 10 stops sending the CTS-to-self packets. Consequently, the second device 20 recognizes the cessation of these packets and resumes its communication with the first device 10. This straightforward approach effectively manages Wi-Fi protection in NAN scenarios, ensuring seamless communication flow and reducing interference.

In a scenario where the first device 10 doesn't support Wi-Fi Non-Neighborhood Aware Networking function (Non-NAN), the first device 10 can initiate Wi-Fi protection by sending the null packet (or other packet types, such as a control packet) with the PM field set to “a first flag” to the second device 20. The second device 20, upon receiving the null packet carrying “PM=the first flag” from the first device 10, temporarily suspends transmissions (TX) to the first device 10. When it needs to leave Wi-Fi protection, the first device 10 sends the null packet with the PM field set to “a second flag” (or other packet types, such as the control packet) to the second device 20. As a result, the second device 20 can resume its communication with the first device 10.

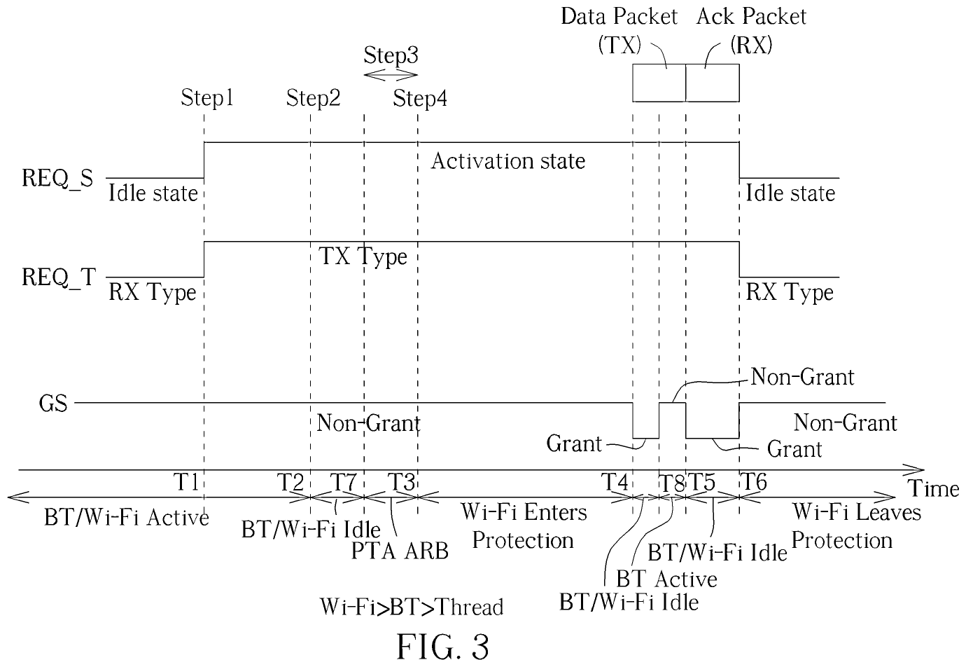

FIG. 3 illustrates the Wi-Fi protection mechanism under a second mode of the wireless communication protection system 100. In the second mode, access priorities of the Wi-Fi network, the BT network, and the Thread network can be expressed as Wi-Fi network>BT network>Thread network. The Thread network has the lowest access priority. The mechanisms of FIG. 3 and FIG. 2 are similar. Differences between FIG. 3 and FIG. 2 are illustrated below. In FIG. 3, when both the BT network and the Wi-Fi network are idle, the first device 10 initiates arbitration (at time point T7) to determine and grant Thread usage. However, if the BT network becomes active while the Thread network is being used (at time point T8), since the Thread network has the lowest access priority, the first device 10 temporarily suspends the Thread network's usage. In the embodiment, after arbitration indicates that the Thread network will be granted usage, the first device 10 can enable the second device 20 to enter Wi-Fi protection (at time point T3), for example, by sending a null packet with PM=“first flag” to the second device 20 or periodically sending CTS-to-self packets. Then, the first device 10 sends the grant signal GS=0 indicating the grant state to the third device (at time point T4), allowing the third device 30 to perform transmission over the Thread network. During the transmission process of the third device 30, if the BT network in the first device 10 needs to become active (at time point T8), the first device 10 immediately sends the grant signal GS=1, indicating non-grant state, to the third device 30 to enable the third device 30 to pause communication. Correspondingly, after the BT network supported by the first device 10 becomes idle, the first device 10 can send the grant signal GS=0 indicating the grant state to the third device. Therefore, the third device 30 can perform reception after receiving the grant signal GS=0 indicating the grant state, such as receiving the acknowledgment (ACK) packet.

Briefly, in FIG. 3, the third device 30 transmits the data packet to the fourth device 40 through the Thread network after the third device 30 receives the grant signal GS=0 indicating the grant state. Communications between the third device 30 and the fourth device 40 are disabled when the BT network supported by the first device 10 is activated. The data packet is re-transmitted (or the ACK packet is received) through the Thread network after the BT network of the first device 10 enters an idle state.

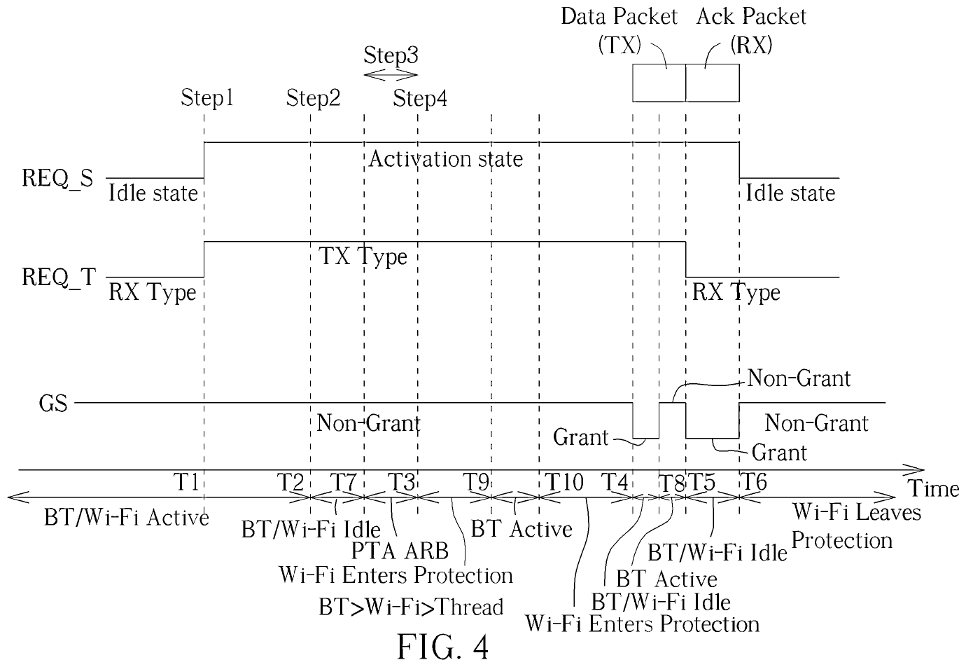

FIG. 4 illustrates the Wi-Fi protection mechanism under a third mode of the wireless communication protection system 100. In this mode, the access priorities of the Wi-Fi network, the BT network, and the Thread network can be expressed as BT network>Wi-Fi network>Thread network. Therefore, the Thread network has the lowest access priority. The mechanisms of FIG. 4 and FIG. 3 are similar. Differences between FIG. 4 and FIG. 3 are illustrated below. In FIG. 4, when the BT network becomes active between time points T9 and T10, it gains access because it has the highest priority. Consequently, the Thread network and the Wi-Fi network are paused temporarily. Similarly, the first device 10 will only initiate arbitration and grant the third device 30 access to the Thread network when both the BT network and the Wi-Fi network are idle. The wireless communication protection system 100 also enters the Wi-Fi protection process before sending the grant signal GS=0 indicating the grant state to the third device 30.

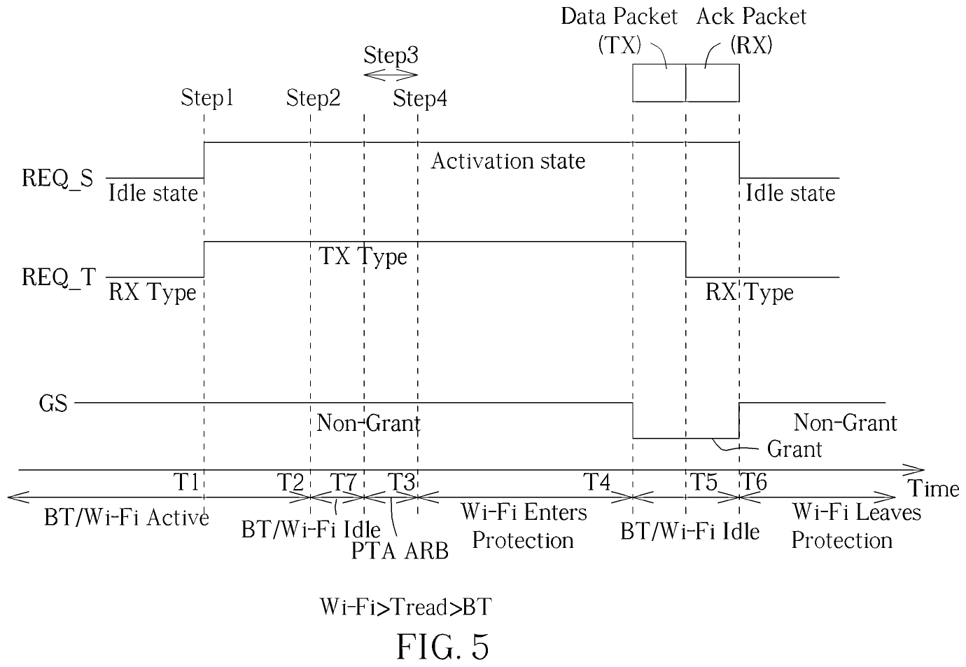

FIG. 5 illustrates the Wi-Fi protection mechanism under a fourth mode of the wireless communication protection system 100. In this mode, the access priorities of the Wi-Fi network, the BT network, and the Thread network can be expressed as Wi-Fi network>Thread network>BT network. Therefore, the Wi-Fi network has the highest access priority. The mechanisms of FIG. 5 and FIG. 2 are similar. Differences between FIG. 5 and FIG. 2 are illustrated below. In FIG. 5, since the Wi-Fi network has the highest access priority, the first device 10 will begin granting the third device 30 access to the Thread network by the PTA process (at time point T7) after the Wi-Fi network is idle. The first device 10 can first initiate the Wi-Fi protection process before sending the grant signal GS=0 indicating the grant state to the third device 30. Since the access priority of the Thread network is higher than that of the BT network, after the third device 30 is granted access to the Thread network, the BT network is suspended.

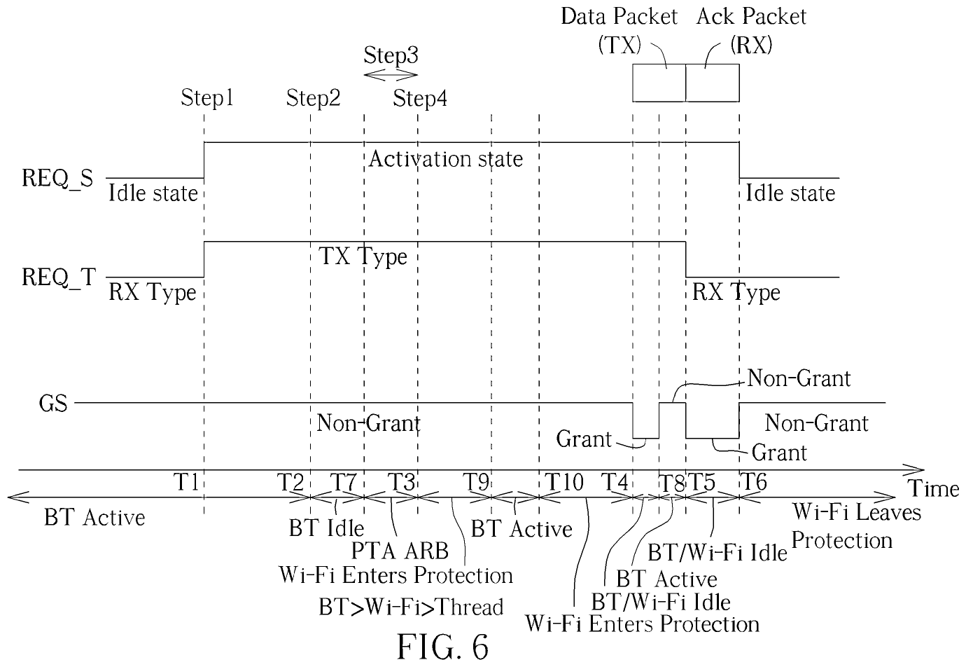

FIG. 6 illustrates the Wi-Fi protection mechanism under a fifth mode of the wireless communication protection system 100. In this mode, the access priorities of the Wi-Fi network, the BT network, and the Thread network can be expressed as BT network>Thread network>Wi-Fi network. Therefore, the BT network has the highest access priority. The mechanisms of FIG. 6 and FIG. 4 are similar. Differences between FIG. 6 and FIG. 4 are illustrated below. In FIG. 6, since the BT network has the highest access priority, the first device 10 will begin granting the third device 30 access to the Thread network by the PTA process (at time point T7) after the BT network is idle. The first device 10 can first initiate the Wi-Fi protection process before sending the grant signal GS=0 indicating the grant state to the third device 30. When the BT network becomes active between time points T9 and T10, it gains access because it has the highest priority. Similarly, during the process of the third device 30 transmitting, if the BT network in the first device 10 needs to become active (at time point T8), the first device 10 immediately sends the grant signal GS=1, indicating non-grant state, to the third device 30 to enable it to pause communication. Correspondingly, after the BT network in the first device 10 becomes idle, the first device 10 can send the grant signal GS=0 indicating the grant state to the third device. Therefore, the third device 30 can perform reception after receiving the grant signal GS=0 indicating the grant state, such as receiving the acknowledgment (ACK) packet.

In the aforementioned embodiment, it can be understood that when the Thread network has the highest access priority, once the first request state signal REQ_S and the first request type signal REQ_T are identified as the sending request by the first device 10 (for example, REQ_S=1 and REQ_T=1), the first device 10 can arbitrate the coexistence of heterogeneous networks. Conversely, when the Thread network has the lowest access priority, the first device 10 delays arbitration of the coexistence of the heterogeneous networks until all other networks of the first device 10 are idle. Furthermore, although the embodiments are illustrated using a scenario where Wi-Fi, BT, and Thread coexist (i.e., the same device supports communication over these three networks), the embodiments are not limited to this exemplified scenario. For instance, it is also applicable to usage scenarios with Wi-Fi and Thread (i.e., the same device supports communication over both Wi-Fi and Thread networks) or to usage scenarios with Wi-Fi and ZigBee (i.e., the same device supports communication over both Wi-Fi and ZigBee networks), and so on. In other words, the embodiments are applicable to devices or scenarios where Wi-Fi coexists with another network (i.e., Thread, ZigBee, or Z-Wave). In practice, Wi-Fi and BT can often be integrated into a single chip, commonly known as a combo chip or a multi-mode wireless chip. Such chips can simultaneously support Wi-Fi and BT communication protocols, providing devices with flexible wireless connectivity.

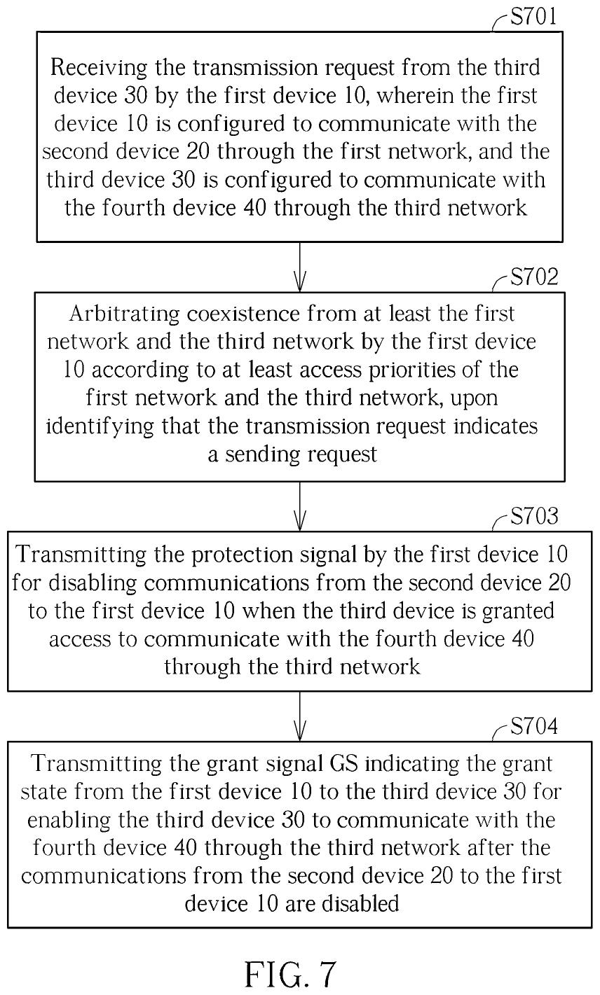

FIG. 7 illustrates a flow chart of performing a wireless communication protection method by the wireless communication protection system 100. The wireless communication protection method includes step S701 to step S704. Any technology or hardware modification falls into the scope of the present invention. Step S701 to step S704 are illustrated below.
Step S701: receiving the transmission request from the third device 30 by the first device 10, wherein the first device 10 is configured to communicate with the second device 20 through the first network, and the third device 30 is configured to communicate with the fourth device 40 through the third network;
Step S702: arbitrating coexistence from at least the first network and the third network by the first device 10 according to at least access priorities of the first network and the third network, upon identifying that the transmission request indicates a sending request;
Step S703: transmitting the protection signal by the first device 10 for disabling communications from the second device 20 to the first device 10 when the third device is granted access to communicate with the fourth device 40 through the third network;
Step S704: transmitting the grant signal GS indicating the grant state from the first device 10 to the third device 30 for enabling the third device 30 to communicate with the fourth device 40 through the third network after the communications from the second device 20 to the first device 10 are disabled.

The details of steps S701 to S704 have been previously illustrated and are therefore omitted here. The wireless communication protection system 100 can reduce/minimize interference between Wi-Fi and Thread communications by temporarily disabling Wi-Fi transmission when Thread needs to transmit data, thus preventing data loss and re-transmission. Furthermore, the wireless communication protection system 100 allows for the prioritization of different wireless technologies based on their access priorities, ensuring that higher-priority communications are given precedence, leading to improved efficiency and performance. By effectively managing interference and prioritizing communication needs, the wireless communication protection method optimizes overall system performance, especially in scenarios where multiple devices need to transmit simultaneously.

In summary, the embodiments disclose a wireless communication protection system and a wireless communication protection method. The wireless communication protection system can effectively reduce coexistence interference in environments where different devices operate under different network protocols. By introducing a mechanism to temporarily disable Wi-Fi transmission from the Wi-Fi device, interference from the Wi-Fi device can be reduced or avoided. Therefore, the wireless communication protection system improves the overall performance and efficiency of wireless communication in multi-network environments.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wireless communication protection method comprising:
receiving a transmission request by a first device from a third device, wherein the first device and the third device are linked via a wired interface, the first device is configured to communicate with a second device through a first network, and the third device is configured to communicate with a fourth device through a third network;
arbitrating coexistence from at least the first network and the third network by the first device according to at least access priorities of the first network and the third network, upon identifying that the transmission request indicates a sending request;
transmitting a protection signal by the first device for disabling communications from the second device to the first device when the third device is granted access to communicate with the fourth device through the third network; and
transmitting a grant signal indicating a grant state from the first device to the third device for enabling the third device to communicate with the fourth device through the third network after the communications from the second device to the first device are disabled.

2. The method of claim 1, wherein the transmission request comprises a first request state signal and a first request type signal, the first request state signal indicates if the transmission request is in an activation state, and the first request type signal indicates if the transmission request is a sending type or a receiving type to communicate with a fourth device.

3. The method of claim 1, wherein the first network is a Wi-Fi network, the third network is a Thread network, the first device supports the first network and a second network, the first device and the third device communicate via a wired interface, the second network is different from the first network and the third network, and the method further comprises:
acquiring access priorities of the first network, the second network, and the third network by the first device.

4. The method of claim 1, wherein transmitting the protection signal by the first device for disabling communications from the second device to the first device comprises:
transmitting a null packet carrying a power management (PM) field from the first device to the second device in a scenario where the first device doesn't support a Neighborhood Aware Networking function (Non-NAN) for disabling the communications from the second device to the first device; and
wherein when the PM field corresponds to a first flag, it indicates that the second device temporarily stops transmitting to the first device.

5. The method of claim 1, wherein transmitting the protection signal by the first device for disabling communications from the second device to the first device comprises:
transmitting clear-to-send (CTS)-to-self packets periodically by the first device during a time interval in a scenario where the first device supports a Neighborhood Aware Networking function (NAN) for disabling the communications from the second device to the first device.

6. The method of claim 1, further comprising:
transmitting a data packet from the third device to the fourth device through the third network after the third device receives the grant signal indicating the grant state;
receiving an acknowledgement signal by the third device from the fourth device after the data packet is completely transmitted; and
transmitting a second transmission request from the third device to the first device after the acknowledgement signal is received by the third device.

7. The method of claim 6, further comprising:
transmitting a grant signal indicating a non-grant state from the first device to the third device for preventing the third device from communicating with the fourth device through the third network; and
enabling the communications between the second device and the first device through the first network after transmitting the grant signal indicating the non-grant state.

8. The method of claim 1, further comprising:
transmitting a data packet from the third device to the fourth device through the third network after the third device receives the grant signal indicating the grant state;
disabling communications between the third device and the fourth device when a second network supported by the first device is activated; and
re-transmitting the data packet from the third device to the fourth device through the third network after the second network of the first device enters an idle state.

9. The method of claim 8, wherein the third network has a lower access priority than the first network and a second network, the first network is a Wi-Fi network and the second network is a Bluetooth (BT) network.

10. The method of claim 1, wherein the third network has a lowest access priority, and arbitrating the coexistence from at least the first network and the third network by the first device comprises:
delaying arbitration of the coexistence from at least the first network and the third network by the first device until all other networks of the first device enter an idle state.

11. A wireless communication protection system comprising:
a first device; and
a third device linked to the first device via a wired interface;
wherein the first device is configured to communicate with a second device through a first network, and the third device is configured to communicate with a fourth device through a third network;
wherein the first device is further configured to receive a transmission request from the third device, to arbitrate coexistence from at least the first network and the third network according to at least access priorities of the first network and the third network, upon identifying that the transmission request indicates a sending request, to transmit a protection signal for disabling communications from the second device to the first device when the third device is granted access to communicate with the fourth device through the third network, and to transmit a grant signal indicating a grant state to the third device for enabling the third device to communicate with the fourth device through the third network after the communications from the second device to the first device are disabled.

12. The system of claim 11, wherein the transmission request comprises a first request state signal and a first request type signal, the first request state signal indicates if the transmission request is in an activation state, and the first request type signal indicates if the transmission request is a sending type or a receiving type to communicate with a fourth device.

13. The system of claim 11, wherein the first network is a Wi-Fi network, the third network is a Thread network, the first device supports the first network and a second network, the first device and the third device communicate via the wired interface, the second network is different from the first network and the third network, and the first device is further configured to acquire access priorities of the first network, the second network, and the third network.

14. The system of claim 11, wherein the first device is further configured to transmit a null packet carrying a power management (PM) field to the second device in a scenario when the first device doesn't support a Neighborhood Aware Networking function (Non-NAN) for disabling the communications from the second device to the first device, and when the PM field corresponds to a first flag, it indicates that the second device temporarily stops transmitting to the first device.

15. The system of claim 11, wherein the first device is further configured to transmit clear-to-send (CTS)-to-self packets periodically during a time interval in a scenario where the first device supports a Neighborhood Aware Networking function (NAN) for disabling the communications from the second device to the first device.

16. The system of claim 11, wherein the third device further configured to transmit a data packet to the fourth device through the third network after the third device receives the grant signal indicating the grant state, to receive an acknowledgement signal from the fourth device after the data packet is completely transmitted, and to transmit a second transmission request to the first device after the acknowledgement signal is received by the third device.

17. The system of claim 16, the first device further configured to transmit a grant signal indicating a non-grant state to the third device for preventing the third device from communicating with the fourth device through the third network, and the communications between the second device and the first device through the first network are enabled after the grant signal indicating the non-grant state is transmitted.

18. The system of claim 11, wherein the third device is further configured to transmit a data packet to the fourth device through the third network after the third device receives the grant signal indicating the grant state, communications between the third device and the fourth device are disabled when a second network supported by the first device is activated, the data packet is re-transmitted from the third device to the fourth device through the third network after the second network of the first device enters an idle state.

19. The system of claim 18, wherein the third network has a lower access priority than the first network and a second network, the first network is a Wi-Fi network and the second network is a Bluetooth (BT) network.

20. The system of claim 11, wherein the third network has a lowest access priority, and after the transmission request is identified by the first device as the sending request, the first device is further configured to delay arbitration of the coexistence from at least the first network and the third network until all other networks of the first device enter an idle state.
